(19) United States
(12) Patent Application Publication
(10) Pub. No.: US 2024/0097784 A1
(43) Pub. Date: Mar. 21, 2024

(54) FREE SPACE OPTICAL COMMUNICATION DEVICE, FREE SPACE OPTICAL COMMUNICATION SYSTEM, AND FREE SPACE OPTICAL COMMUNICATION METHOD

(71) Applicant: NEC Corporation, Tokyo (JP)

(72) Inventors: Koya TAKATA, Tokyo (JP); Atsushi KAMOI, Tokyo (JP); Hisashi MIZUMOTO, Tokyo (JP); Masaki AIZONO, Tokyo (JP)

(73) Assignee: NEC Corporation, Tokyo (JP)

(21) Appl. No.: 18/207,490

(22) Filed: Jun. 8, 2023

(30) Foreign Application Priority Data
Sep. 16, 2022 (JP) 2022-148227

(51) Int. Cl. H04B 10/11

(52) U.S. Cl. CPC H04B 10/11

(57) ABSTRACT

A free space optical communication device includes: a plurality of light transmitting/receiving sections; and at least one processor configured to execute: a communication control process of controlling communication which is to be carried out via the plurality of light transmitting/receiving sections, in the communication control process, the at least one processor causing two or more light transmitting/receiving sections of the plurality of light transmitting/receiving sections to transmit same pieces of information in parallel according to respective different communication schemes.

This Nonprovisional application claims priority under 35 U.S.C. § 119 on Patent Application No. 2022-148227 filed in Japan on Sep. 16, 2022, the entire contents of which are hereby incorporated by reference.

### TECHNICAL FIELD

The present invention relates to a free space optical communication device, a free space optical communication system, and a free space optical communication method.

### BACKGROUND ART

As a communication system that realizes spatial multiplex transmission, there has been known a system disclosed in Patent Literature 1, for example. According to the system disclosed in Patent Literature 1, a transmitting device includes: a first modulating section that modulates a first transmission data to generate a first modulation signal; a second modulating section that modulates a second transmission data to generate a second modulation signal having a frequency lower than that of the first modulation signal and an amplitude larger than that of the first modulation signal; a signal adding section that adds up the first modulation signal generated by the first modulating section and the second modulation signal generated by the second modulating section to generate an added modulation signal; and a light emission control section that causes a plurality of light sources to emit light on the basis of the added modulation signal generated by the signal adding section.

Patent Literature 2 discloses a technique according to which: the same data is transmitted through a multiplexed path; and data of any of the communication paths is selected by a switching process section provided on a receiver side and is then output as reception data.

Patent Literature 3 discloses a technique that carries out wavelength multiplexing to yield an optical multiplexed signal transmitted optically in a free space between a transmitter and a receiver.

### CITATION LIST

### Patent Literature

[Patent Literature 1]
Japanese Patent Application Publication, Tokukai, No. 2011-029871
[Patent Literature 2]
International Publication No. WO 2006/095411
[Patent Literature 3]
Japanese Patent Application Publication, Tokukai, No. 2000-124860

### SUMMARY OF INVENTION

### Technical Problem

In the free space optical communication, a variation in communication environment affects the communication. One example of the communication environment is weather such as fog or rain. Thus, there has been a demand for development of a free space optical communication technique that is less affected by such a variation in communication environment.

An example aspect of the present invention was made in view of the above problem, and has an example object to provide a free space optical communication technique that is less affected by a variation in communication environment and that has higher availability than conventional techniques.

### Solution to Problem

A free space optical communication device in accordance with an example aspect of the present invention includes: a plurality of light transmitting/receiving sections; and at least one processor configured to execute: a communication control process of controlling communication which is to be carried out via the plurality of light transmitting/receiving sections, in the communication control process, the at least one processor causing two or more light transmitting/receiving sections of the plurality of light transmitting/receiving sections to transmit same pieces of information in parallel according to respective different communication schemes.

A free space optical communication system in accordance with an example aspect of the present invention includes: a plurality of free space optical communication devices, at least two or more free space optical communication devices of the plurality of free space optical communication devices each including: a plurality of light transmitting/receiving sections;

and at least one processor configured to execute: a communication control process of controlling communication which is to be carried out via the plurality of light transmitting/receiving sections, in the communication control process, the at least one processor causing two or more light transmitting/receiving sections of the plurality of light transmitting/receiving sections to transmit same pieces of information in parallel according to respective different communication schemes.

A free space optical communication method in accordance with an example aspect of the present invention includes: controlling communication which is to be carried out via a plurality of light transmitting/receiving sections, the controlling the communication including: causing two or more light transmitting/receiving sections of the plurality of light transmitting/receiving sections to transmit same pieces of information in parallel according to respective different communication schemes.

### Advantageous Effects of Invention

In accordance with an example aspect of the present invention, it is possible to provide a free space optical communication technique that is less affected by a variation in environmental condition and that has higher availability than conventional techniques.

### BRIEF DESCRIPTION OF DRAWINGS

FIG. 1 is a block diagram illustrating a configuration of a free space optical communication system including a free space optical communication device in accordance with a first example embodiment of the present invention.

FIG. 2 is a view illustrating a process flow of a free space optical communication method in accordance with the first example embodiment of the present invention.

FIG. 3 is a block diagram illustrating a configuration of a free space optical communication system including a free space optical communication device in accordance with a second example embodiment of the present invention.

FIG. 4 is a block diagram illustrating a configuration of a light transmitting/receiving section included in the free space optical communication device in accordance with the second example embodiment of the present invention.

FIG. 5 is a block diagram illustrating a configuration of a communication control section of the free space optical communication device in accordance with the second example embodiment of the present invention.

FIG. 6 is a view illustrating a process flow of a free space optical communication method in accordance with the second example embodiment of the present invention.

FIG. 7 is a block diagram illustrating a hardware configuration of a computer, which is one implementation example of each of the free space optical communication devices in accordance with the example embodiments of the present invention.

### DESCRIPTION OF EMBODIMENTS

### First Example Embodiment

The following description will discuss a first example embodiment of the present invention in detail with reference to the drawings. The present example embodiment is a basic form of example embodiments described later.

(Configuration of Free Space Optical Communication System)

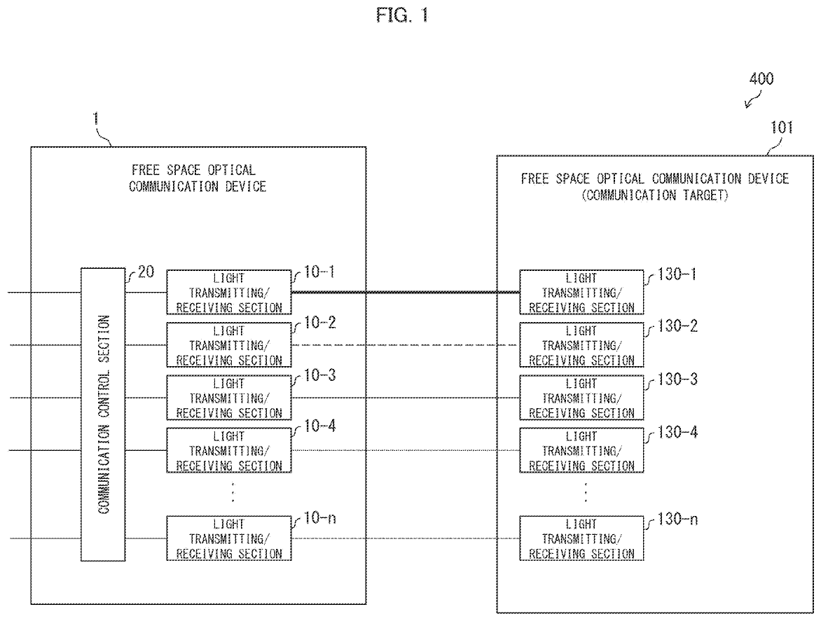

The following will describe, with reference to FIG. 1, a configuration of a free space optical communication system including a free space optical communication device in accordance with the present example embodiment. FIG. 1 is a block diagram illustrating a configuration of a free space optical communication system 400. The free space optical communication system 400 includes a plurality of free space optical communication devices 1 and 101, and realizes spatial multiplex transmission through simultaneous connection of a plurality of beams. FIG. 1 shows an example including two free space optical communication devices 1 and 101. However, the number of free space optical communication devices is not limited to this. In the description below, the one free space optical communication device 1 will be mainly discussed, and the other free space optical communication device 101 will be discussed as a communication target of the free space optical communication device 1. However, the free space optical communication devices 1 and 101 can be configured identically.

(Configuration of Free Space Optical Communication Device)

As shown in FIG. 1, the free space optical communication device 1 in accordance with the present example embodiment includes a plurality of light transmitting/receiving sections 10-1 to 10-n and a communication control section 20. Each of the plurality of light transmitting/receiving sections 10-1 to 10-n is one implementation example of a light transmitting/receiving section recited in the claims, and the communication control section 20 is one implementation example of at least one processor recited in the claims.

(Transmitting/Receiving Sections 10-1 to 10-n) Each of the plurality of light transmitting/receiving sections 10-1 to 10-n is configured to be capable of transmitting an optical communication medium (light transmission) and of receiving the optical communication medium (light reception). The optical communication medium transmitted from each of the plurality of light transmitting/receiving sections 10-1 to 10-n is received by a corresponding one of a plurality of light transmitting/receiving sections 130-1 to 130-n in the free space optical communication device 101, which is a communication target. Conversely, the optical communication medium transmitted from each of the plurality of light transmitting/receiving sections 130-1 to 130-n in the free space optical communication device 101, which is the communication target, is received by a corresponding one of the plurality of light transmitting/receiving sections 10-1 to 10-n in the free space optical communication device 1.

The optical communication medium to be transmitted/received is a directional optical communication medium. A specific example of the optical communication medium may be electromagnetic wave of a high frequency region including a frequency of not less than approximately 10 GHz. However, the present example embodiment is not limited to this. Examples of the electromagnetic wave of the frequency region encompass millimeter wave, submillimeter wave, infrared light, visible light, and ultraviolet light.

In an example, each of the light transmitting/receiving sections 10-1 to 10-n emits electromagnetic wave of the frequency region in such a manner that the electromagnetic wave is directed at an angle within a given angle range. Consequently, the electromagnetic wave is used for communication as the above-described directional optical communication medium. Here, in a specific example, in order to direct the electromagnetic wave of the above frequency region, each of the light transmitting/receiving sections 10-1 to 10-n may be configured to include, for example, the followings:
A beam forming antenna that emits millimeter wave or submillimeter wave in such a manner that the millimeter wave or the submillimeter wave is directed at an angle within a given angle range;
A collimator that collimates infrared light, visible light, or ultraviolet light;
A laser oscillator that generates a laser beam of infrared light, visible light, or ultraviolet light; and/or
A modulator that modulates a laser beam by changing the phase of crystal.

However, the present example embodiment is not limited to such a configuration.

When each of the light transmitting/receiving sections 10-1 to 10-n emits the electromagnetic wave of the above frequency range, which is an optical communication medium, in such a manner that the electromagnetic wave is directed at a given angle, an energy density of the optical communication medium is increased. This enables communication, via the optical communication media, with a communication target at a farther location.

(Communication Control Section 20) The communication control section 20 controls communication via the plurality of light transmitting/receiving sections 10-1 to 10-n. Specifically, the communication control section 20 causes two or more light transmitting/receiving sections of the plurality of light transmitting/receiving sections 10-1 to 10-n to transmit the same pieces of information in parallel according to respective different communication schemes. The two or more light transmitting/receiving sections can be, for example, light transmitting/receiving sections 10-1 and 10-2. However, this is not limitative.

The communication control section 20 causes the light transmitting/receiving sections 10-1 and 10-2 to transmit the above information according to respective different communication schemes. The communication control section can employ, for example, communication schemes having respective different transmission capacities. A communication scheme having a larger transmission capacity can be, for example, a communication scheme not including error correction. Meanwhile, a communication scheme having a smaller transmission capacity can be, for example, a communication scheme which includes error correction and with which retransmission can be easily carried out (communication is hardly interrupted). With the configuration in which the same pieces of information are transmitted in parallel according to these two types of communication schemes, even in a case where transmission according to one communication scheme is failed due to an effect of the communication environment, transmission according to the other communication scheme can be completed in the same environment.

As discussed above, the free space optical communication device 1 in accordance with the present example embodiment and the free space optical communication system 400, which includes the free space optical communication device 1, are each configured to include: the plurality of light transmitting/receiving sections; and the communication control section that controls communication which is to be carried out via the plurality of light transmitting/receiving sections, the communication control section causing two or more light transmitting/receiving sections of the plurality of light transmitting/receiving sections to transmit the same pieces of information in parallel according to the respective different communication schemes. Therefore, in accordance with the present example embodiment, even in a case where an environmental condition varies, information is transmitted according to a communication scheme suitable for the varied environmental condition. In view of this, it can be said that the free space optical communication device 1 and the free space optical communication system 400, which includes the free space optical communication device 1, have high availability.

(Flow of Free Space Optical Communication Method)

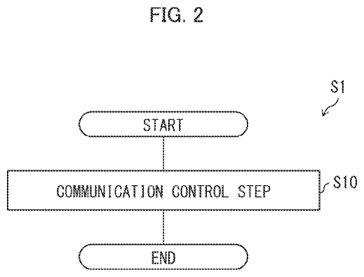

The following will describe, with reference to FIG. 2, a flow of a free space optical communication method 51 in accordance with the present example embodiment. FIG. 2 is a flowchart illustrating a flow of the free space optical communication method 51.

As shown in FIG. 2, the free space optical communication method 51 includes a communication control step (S10) that controls communication which is to be carried out via the plurality of light transmitting/receiving sections. The communication control step (S10) includes causing two or more light transmitting/receiving sections of the plurality of light transmitting/receiving sections to transmit the same pieces of information in parallel according to respective different communication schemes.

That is, in step S10, the communication control section carries out control to adjust information to be transmitted by the two or more light transmitting/receiving sections (light transmitting/receiving sections 10-1 and 10-2) and to cause the two or more light transmitting/receiving sections (light transmitting/receiving sections 10-1 and 10-2) to transmit the information in parallel according to respective different communication schemes.

As discussed above, with the free space optical communication method Si in accordance with the present example embodiment, even in a case where the communication environment varies, information is transmitted according to a communication scheme suitable for the varied communication environment. In view of this, it can be said that the free space optical communication method Si has high availability.

### Second Example Embodiment

The following description will discuss a second example embodiment of the present invention in detail with reference to the drawings. Note that members having identical functions to those of the first example embodiment are given identical reference signs, and a description thereof will be omitted.

(Configuration of Free Space Optical Communication System)

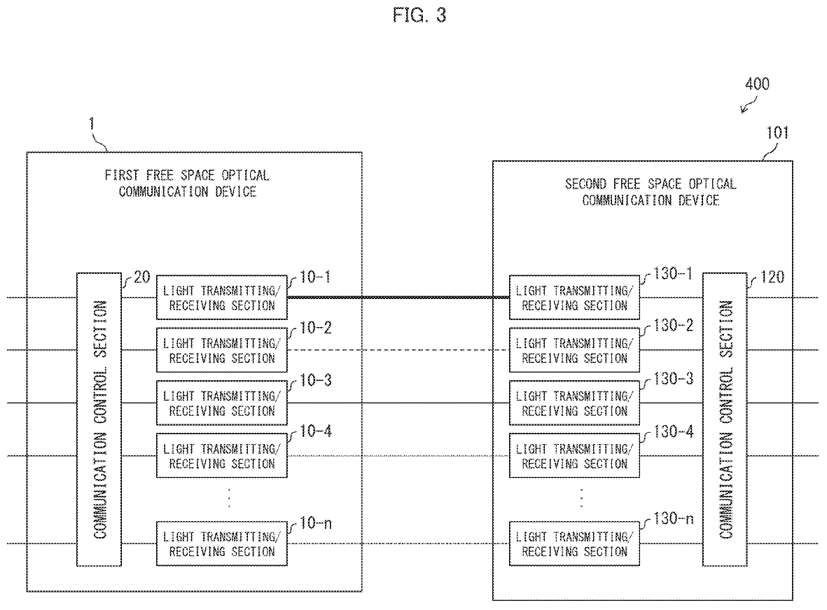

The following will describe, with reference to FIG. 3, a configuration of a free space optical communication system including a free space optical communication device in accordance with the present example embodiment. FIG. 3 is a block diagram illustrating a configuration of a free space optical communication system 400. The free space optical communication system 400, which includes a first free space optical communication device 1 including a plurality of light transmitting/receiving sections 10-1 to 10-n and a second free space optical communication device 101 including a plurality of light transmitting/receiving sections 130-1 to 130-n corresponding to the plurality of light transmitting/receiving sections 10-1 to 10-n, is a system for realizing spatial multiplex transmission. FIG. 3 shows an example including first and second free space optical communication devices 1 and 101. However, the number of free space optical communication devices is not limited to this. In the description below, the first free space optical communication device 1 will be mainly discussed, and the second free space optical communication device 101 will be discussed as a communication target of the first free space optical communication device 1. Note that these free space optical communication devices 1 and 101 can be configured identically.

(First Free Space Optical Communication Device 1) As shown in FIG. 3, the first free space optical communication device 1 in accordance with the present example embodiment includes the plurality of light transmitting/receiving sections 10-1 to 10-n and a communication control section 20. Each of the plurality of light transmitting/receiving sections 10-1 to 10-n is one implementation example of a light transmitting/receiving section recited in the claims, and the communication control section 20 is one implementation example of at least one processor recited in the claims.

(Light Transmitting/Receiving Sections 10-1 to 10-n)

Since an optical communication medium to be transmitted/received by each of the plurality of light transmitting/receiving sections 10-1 to 10-n is as discussed above, a description thereof will be omitted here.

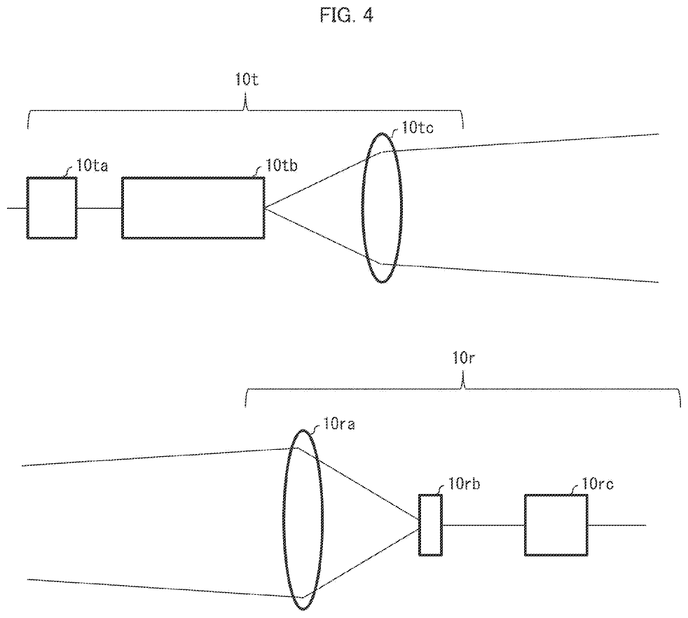

Each of the light transmitting/receiving sections 10-1 to 10-n can employ a known light transmitting/receiving section applicable to free space optical communication. In an example, each of the light transmitting/receiving sections 10-1 to 10-n employs a configuration shown in FIG. 4. FIG. 4 shows an example aspect in which a transmitting section 10t that transmits the optical communication medium and a receiving section 10r that receives the optical communication medium are provided separately. The transmitting section 10t is configured such that, upon reception of a signal from an electrical-optical converting section 10ta, a laser light source 10tb emits a laser beam (optical communication medium) so that the laser beam is transmitted to the outside through a collimator lens 10tc. Meanwhile, the receiving section 10r is configured such that a lens 10ra condenses the laser beam coming from the outside, a light receiving element 10rb receives the laser beam, and an electrical-optical converting section 10rc converts the laser beam into an electric signal.

(Communication Control Section 20)

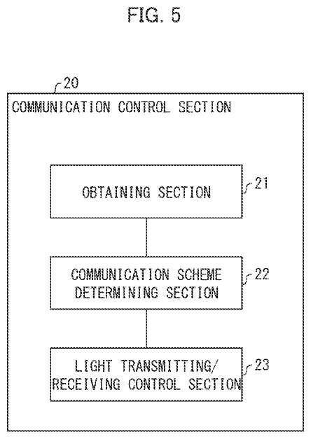

The communication control section 20 shown in FIG. 3 may be the one having functions similar to those of the communication control section 20 discussed in the foregoing first example embodiment. The following description will discuss, with reference to FIG. 5, a configuration of the communication control section 20 included in the free space optical communication device 1 in accordance with the present example embodiment.

FIG. 5 is a block diagram illustrating a configuration of the communication control section 20. The communication control section 20 includes an obtaining section 21, a communication scheme determining section 22, and a light transmitting/receiving control section 23.

The obtaining section 21 obtains information of a communication environment. One example of the information of the communication environment is a noise. The noise is small in a good communication environment. The obtaining section 21 can obtain a noise by a known method.

The obtaining section 21 is not limited to the aspect of obtaining a noise. Another known method capable of obtaining the information of the communication environment can be employed.

Here, examples of the communication environment include weather and a time slot. Regarding the weather, a good communication environment may be fine weather. However, this is not limitative. Regarding the time slot, a good communication environment may be a night time slot (particularly, a late night time slot).

The communication scheme determining section 22 determines, on the basis of the information of the communication environment (hereinafter, sometimes referred to as “environment information”) obtained by the obtaining section 21, communication schemes of respective two or more light transmitting/receiving sections (for example, the light transmitting/receiving section 10-1 and the light transmitting/receiving section 10-2). For example, the communication scheme determining section 22 can determine, on the basis of a communication capacity, a delay time, or a retransmission rate, the communication schemes of the respective light transmitting/receiving sections 10-1 and 10-2. One example of the communication scheme is a modulation scheme. However, this is not limitative. One of the two or more light transmitting/receiving sections may be a light transmitting/receiving section that employs a communication scheme including error correction, and the other may be a light transmitting/receiving section that employs a communication scheme including a countermeasure against a delay time.

In a case where the information obtained by the obtaining section 21 is information indicating that there is no noise or information indicating that there is substantially no noise, the communication scheme determining section 22 employs a communication scheme having a large transmission capacity. The communication scheme having a large transmission capacity is a scheme not including error correction. Examples of such a communication scheme include multi-level modulation and phase modulation. Meanwhile, in a case where the information obtained by the obtaining section 21 is information indicating that there is a noise, the communication scheme determining section 22 employs a communication scheme which includes error correction and with which retransmission is easily carried out. In this case, although the transmission capacity is small, the communication is less prone to be interrupted. In an example, the communication scheme determining section 22 can determine a communication scheme with reference to previous data including previous communication environment (weather) and a communication scheme associated with each other.

The light transmitting/receiving control section 23 causes two or more light transmitting/receiving sections (for example, the light transmitting/receiving sections 10-1 and 10-2) to transmit the same pieces of information in parallel according to the communication schemes determined by the communication scheme determining section 22.

The same pieces of information transmitted by the light transmitting/receiving sections 10-1 and 10-2 under control of the light transmitting/receiving control section 23 are received by any of the light transmitting/receiving sections 130-1 to 130-n of the second free space optical communication device 101.

(Second Free Space Optical Communication Device 101)

The second free space optical communication device 101 includes the plurality of light transmitting/receiving sections 130-1 to 130-n corresponding to the plurality of light transmitting/receiving sections 10-1 to 10-n of the first free space optical communication device 1. The second free space optical communication device 101 further includes a communication control section 120.

(Light Transmitting/Receiving Sections 130-1 to 130-n)

Each of the light transmitting/receiving sections 130-1 to 130-n is identical in configuration to each of the light transmitting/receiving sections 10-1 to 10-n. The same pieces of information transmitted by the above-described light transmitting/receiving sections 10-1 and 10-2 are received by any of the light transmitting/receiving sections 130-1 to 130-n. Depending on the communication environment, the information (optical communication medium) from either (for example, the light transmitting/receiving section 10-1) of the light transmitting/receiving sections 10-1 and 10-2 that have emitted the same pieces of information is received by a single light transmitting/receiving section (for example, the light transmitting/receiving section 130-1). Alternatively, the pieces of information from the light transmitting/receiving sections 10-1 and 10-2 that have emitted the same pieces of information are received by respective different two light transmitting/receiving sections (for example, the light transmitting/receiving sections 130-1 and 130-2).

(Communication Control Section 120)

The communication control section 120 is identical in configuration to the communication control section 20 included in the first free space optical communication device 1. That is, the communication control section 120 is one implementation example of at least one processor recited in the claims. The communication control section 120 controls each of the configurations in the light transmitting/receiving sections 130.

The communication control section 120 specifies which of the light transmitting/receiving sections 130 has receives the pieces of information from the above-described two or more light transmitting/receiving sections (the light transmitting/receiving sections 10-1 and 10-2). In an example, the obtaining section 21 (FIG. 5) provided to the communication control section 20 obtains the information received by the light transmitting/receiving section 130, whereby the light transmitting/receiving control section 23 (FIG. 5) can specify a communication scheme of the received information. The communication control section 120 notifies, via any of the light transmitting/receiving sections 130, the communication scheme of the received information to any of the light transmitting/receiving sections 10 of the first free space optical communication device 1. The communication scheme in this notification is identical to the communication scheme of the received information. According to the communication scheme thus notified, the communication control section 20 of the first free space optical communication device 1 carries out free space optical communication via the light transmitting/receiving sections 10.

Here, in a case where the same pieces of information from the two or more light transmitting/receiving sections (the light transmitting/receiving sections 10-1 and 10-2) are received by two or more light transmitting/receiving sections (the light transmitting/receiving sections 130-1 and 130-2), a communication scheme having a better communication quality is employed.

Even in a case where the information can be received by any of the light transmitting/receiving sections 130, if the reception quality is not good, the communication control section 120 causes any of the light transmitting/receiving sections 130 to transmit, to any of the light transmitting/receiving sections 10 of the first free space optical communication device 1, information which instructs to change the communication scheme. In this case, in the communication control section 20 of the first free space optical communication device 1 that has received the information which instructs to change the communication scheme, the communication scheme determining section 22 determines, from among communication schemes different from the previously determined communication scheme, a suitable communication scheme on the basis of the environment information previously obtained by the obtaining section 21. Then, the above-discussed communication control process will be carried out again.

(Effects of Free Space Optical Communication Device) The free space optical communication device (the first free space optical communication device 1 and the second free space optical communication device 101) in accordance with the present example embodiment and the free space optical communication system 400, which includes these free space optical communication devices, are each configured to include: the plurality of light transmitting/receiving sections; and the communication control section that controls communication which is to be carried out via the plurality of light transmitting/receiving sections, the communication control section causing two or more light transmitting/receiving sections of the plurality of light transmitting/receiving sections to transmit the same pieces of information in parallel according to respective different communication schemes. Therefore, in accordance with the present example embodiment, even in a case where the communication environment varies, the information is transmitted according to a communication scheme suitable for the varied communication environment. In view of this, it can be said that the free space optical communication device 1 and the free space optical communication system 400, which includes the free space optical communication device 1, have high availability.

Further, the free space optical communication device (the first free space optical communication device 1 and the second free space optical communication device 101) in accordance with the present example embodiment is configured such that the communication control section 20 determines the communication schemes of the respective two or more light transmitting/receiving sections on the basis of a communication capacity, a delay time, or a retransmission rate. Thus, in accordance with the present example embodiment, it is possible to carry out communication according to an optimum communication scheme.

(Flow of Free Space Optical Communication Method)

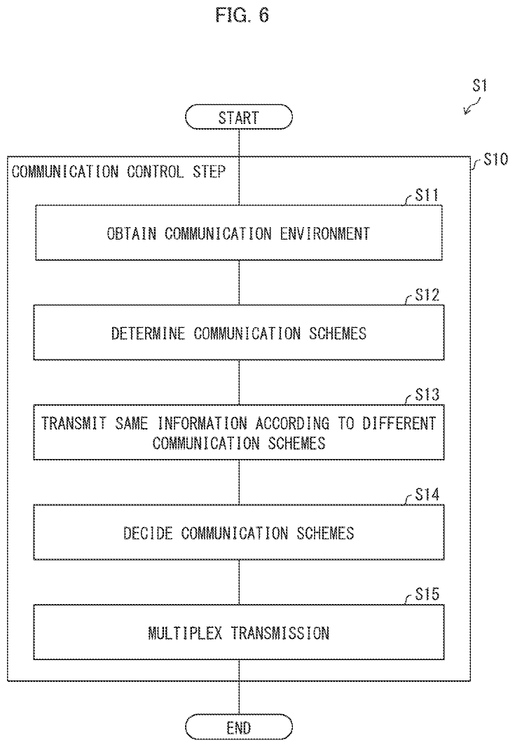

The following will describe, with reference to FIG. 6, a flow of a free space optical communication method 51 in accordance with the present example embodiment. FIG. 6 is a flowchart illustrating a flow of the free space optical communication method 51 to be performed by the free space optical communication system in accordance with the present example embodiment.

As shown in FIG. 6, the free space optical communication method 51 includes controlling communication which is to be carried out via the plurality of light transmitting/receiving sections (communication control step, step S10). The step S10 includes steps S11, S12, S13, S14, and S15.

(Step S11)

In step S11, the obtaining section 21 of the communication control section 20 obtains a communication environment. Since the obtaining has been discussed in detail above, a description thereof will be omitted here.

(Step S12)

In step S12, the communication scheme determining section 22 of the communication control section 20 determines communication schemes used for communication. Since the determining has been discussed in detail above, a description thereof will be omitted here.

(Step S13)

In step S13, the same pieces of information are emitted in parallel from two or more light transmitting/receiving sections 10-1 and 10-2 according to the communication schemes determined by the communication scheme determining section 22 of the communication control section 20.

(Step S14)

In step S14, on the basis of the information transmitted in step S13, the communication schemes are decided by the communication control section 120 of the second free space optical communication device 101 and the communication control section 20 of the first free space optical communication device 1. This has been discussed in the description of the communication scheme determining section 22, and therefore a description thereof will be omitted.

(Step S15)

In step S15, the communication schemes decided in step S14 are used to carry out communication between the plurality of light transmitting/receiving sections 10-1 to 10-n and the plurality of light transmitting/receiving sections 130-1 to 130-n (multiplex transmission).

(Effects of Free Space Optical Communication Method)

As discussed above, the free space optical communication method in accordance with the present example embodiment includes: controlling communication which is to be carried out via a plurality of light transmitting/receiving sections, the controlling the communication including causing two or more light transmitting/receiving sections of the plurality of light transmitting/receiving sections to transmit the same pieces of information in parallel according to respective different communication schemes. With the method in accordance with the present example embodiment, even in a case where the communication environment varies, the information is transmitted according to a communication scheme suitable for the varied communication environment. In view of this, it can be said that the free space optical communication method 51 has high availability.

[Variation 1]

In a basic mode of each of the above-described example embodiments, free space optical communication is carried out according to decided communication schemes and the communication schemes would not be changed. However, this is not limitative. Alternatively, free space optical communication may be carried out according to the decided communication schemes and the communication schemes may be changed at a given timing.

In Variation 1, among a plurality of light transmitting/receiving sections 10-1 to 10-n, a light transmitting/receiving section for control (for example, a light transmitting/receiving section 10-3) which is not two or more light transmitting/receiving sections (for example, light transmitting/receiving sections 10-1 and 10-2) that transmit the same pieces of information is used to notify, to a light transmitting/receiving section (for example, a light transmitting/receiving section 130-3) of a second free space optical communication device, a communication scheme to be changed and a timing to make the change. Here, the “communication scheme to be changed” can be a mode in which the modulation scheme is not changed but an error correction rate (code rate) is changed.

The given timing may be a timing at which the weather changes or a time (a point of time).

[Variation 2]

In the foregoing example embodiments, the light transmitting/receiving sections that transmit the same pieces of information in parallel according to respective different communication schemes are one light transmitting/receiving section 10-1 and one light transmitting/receiving section 10-2. However, this is not limitative. The light transmitting/receiving sections that carry out transmission according to a certain communication scheme may be three light transmitting/receiving sections (for example, light transmitting/receiving sections 10-1, 10-3, and 10-5) and the light transmitting/receiving sections that carry out transmission according to another communication scheme may be three light transmitting/receiving sections (for example, light transmitting/receiving sections 10-2, 10-4, and 10-6).

In the example aspect in which the number of light transmitting/receiving sections that carry out transmission according to a certain communication scheme is two or more, the same signal modulated by the communication control section 20 may be distributed to the two or more light transmitting/receiving sections. This can reduce the scale of the device, as compared to an aspect in which signals individually modulated by the communication control section for respective light transmitting/receiving sections are supplied. Note that the modulation may be carried out on an electric signal or an optical signal.

[Software Implementation Example]

Part of or the whole of functions of the free space optical communication devices 1 and 101 can be realized by hardware such as an integrated circuit (IC chip) or can be alternatively realized by software.

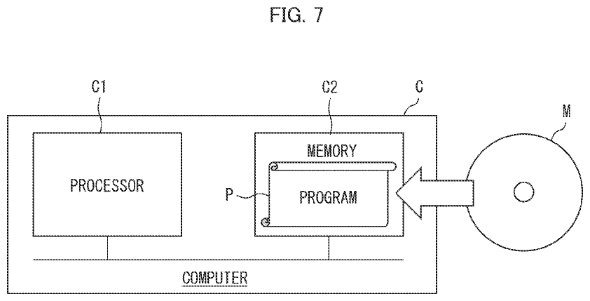

In the latter case, each of the free space optical communication devices 1 and 101 is realized by, for example, a computer that executes instructions of a program that is software realizing the foregoing functions. FIG. 7 shows an example of such a computer (hereinafter, referred to as a “computer C”). The computer C includes at least one processor C1 and at least one memory C2. The memory C2 has a program P stored therein, the program P causing the computer C to operate as the free space optical communication devices 1 and 101. In the computer C, the processor C1 reads and executes the program P from the memory C2, thereby realizing the functions of the free space optical communication devices 1 and 101.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by the computer C. Examples of the storage medium M encompass a tape, a disk, a card, a memory, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

[Supplementary Note 1] The present invention is not limited to the example embodiments, but can be altered by a skilled person in the art within the scope of the claims. The present invention also encompasses, in its technical scope, any embodiment derived by combining technical means disclosed in differing embodiments.

[Supplementary Note 2] Some or all of the above embodiments can be described as below. Note, however, that the present invention is not limited to aspects described below.

(Supplementary Remarks 1)

A free space optical communication device including:
a plurality of light transmitting/receiving sections; and
a communication control section that controls communication which is to be carried out via the plurality of light transmitting/receiving sections,
the communication control section causing two or more light transmitting/receiving sections of the plurality of light transmitting/receiving sections to transmit same pieces of information in parallel according to respective different communication schemes.

With the above configuration, even in a case where the communication environment varies, the information is transmitted according to a communication scheme suitable for the varied communication environment. Therefore, it is possible to provide a free space optical communication device having higher availability than conventional configurations.

(Supplementary Remarks 2)

The free space optical communication device described in Supplementary Remarks 1, wherein:
the communication control section determines the communication schemes of the respective two or more light transmitting/receiving sections on a basis of a communication capacity, a delay time, or a retransmission rate.

With the above configuration, it is possible to deal with a variation in communication environment.

(Supplementary Remarks 3)

The free space optical communication device described in Supplementary Remarks 1, wherein:
the communication control section changes the communication schemes of the respective two or more light transmitting/receiving sections at a given timing, and causes, among the plurality of light transmitting/receiving sections, a light transmitting/receiving section which is not the two or more light transmitting/receiving sections to transmit the change.

(Supplementary Remarks 4)

The free space optical communication device described in Supplementary Remarks 1, wherein:
the communication control section causes two or more light transmitting/receiving sections of the plurality of light transmitting/receiving sections to transmit the same pieces of information according to a certain communication scheme of the respective different communication schemes; and
the communication control section distributes a same signal to the two or more light transmitting/receiving sections.

With the above configuration distributes, the same signal is distributed. Therefore, it is possible to reduce the scale of the device, as compared to a mode in which a dedicated communication control section is provided to a respective one of the two or more light transmitting/receiving sections.

(Supplementary Remarks 5)

The free space optical communication device described in Supplementary Remarks 1, wherein:
the communication scheme is a modulation scheme.

With the above configuration, it is possible to deal with a varied communication environment.

(Supplementary Remarks 6)

The free space optical communication device described in Supplementary Remarks 1, wherein:
the two or more light transmitting/receiving sections include (a) a light transmitting/receiving section that employs a communication scheme including error correction and (b) a light transmitting/receiving section that employs a communication scheme including a countermeasure against a delay time.

(Supplementary Remarks 7)

A free space optical communication system including:
a plurality of free space optical communication devices,
at least two or more free space optical communication devices of the plurality of free space optical communication devices each including:
a plurality of light transmitting/receiving sections; and
a communication control section that controls communication which is to be carried out via the plurality of light transmitting/receiving sections,
   the communication control section causing two or more light transmitting/receiving sections of the plurality of light transmitting/receiving sections to transmit same pieces of information in parallel according to respective different communication schemes.

With the above configuration, even in a case where the communication environment varies, the information is transmitted according to a communication scheme suitable for the varied communication environment. Therefore, it is possible to provide a free space optical communication system having higher availability than conventional configurations.

(Supplementary Remarks 8)

A free space optical communication method including: controlling communication which is to be carried out via a plurality of light transmitting/receiving sections,
the controlling the communication including:
causing two or more light transmitting/receiving sections of the plurality of light transmitting/receiving sections to transmit same pieces of information in parallel according to respective different communication schemes.

With the method in accordance with the present example embodiment, even in a case where the communication environment varies, the information is transmitted according to a communication scheme suitable for the varied communication environment. Therefore, it is possible to provide a free space optical communication environment having higher availability than conventional configurations.

(Supplementary Remarks 9)

A program causing a computer to operate as a free space optical communication device described in any one of Supplementary Remarks 1 to 6, the program causing the computer to function as each of the sections.

(Supplementary Remarks 10)

A free space optical communication device including at least one processor configured to execute:
a communication process of carrying out communication via a plurality of light transmitting/receiving sections; and
a communication control process of controlling the communication,
the communication control process executing a process of causing two or more light transmitting/receiving sections of the plurality of light transmitting/receiving sections to transmit the same pieces of information in parallel according to respective different communication schemes.

Note that the free space optical communication device may further include a memory. In the memory, a program causing the processor to execute each of the processes may be stored. The program may can be stored in a non-transitory, tangible storage medium capable of being read by a computer.

### REFERENCE SIGNS LIST

1: free space optical communication device
10, 10-1 to 10-n: light transmitting/receiving section
20, 120: communication control section
21: obtaining section
22: communication scheme determining section
23: light transmitting/receiving control section
101: free space optical communication device (free space optical communication device which is communication target)
130, 130-1 to 130-n: light transmitting/receiving section (light transmitting/receiving section of free space optical communication device which is communication target)
400: free space optical communication system

1. A free space optical communication device comprising:
a plurality of light transmitting/receiving sections; and
at least one processor configured to execute:
a communication control process of controlling communication which is to be carried out via the plurality of light transmitting/receiving sections,
in the communication control process, the at least one processor causing two or more light transmitting/receiving sections of the plurality of light transmitting/receiving sections to transmit same pieces of information in parallel according to respective different communication schemes.

2. The free space optical communication device according to claim 1, wherein:
in the communication control process, the at least one processor determines the communication schemes of the respective two or more light transmitting/receiving sections on a basis of a communication capacity, a delay time, or a retransmission rate.

3. The free space optical communication device according to claim 1, wherein:
in the communication control section, the at least one processor changes the communication schemes of the respective two or more light transmitting/receiving sections at a given timing, and causes, among the plurality of light transmitting/receiving sections, a light transmitting/receiving section which is not the two or more light transmitting/receiving sections to transmit the change.

4. The free space optical communication device according to claim 1, wherein:
in the communication control process, the at least one processor causes two or more light transmitting/receiving sections of the plurality of light transmitting/receiving sections to transmit the same pieces of information according to a certain communication scheme of the respective different communication schemes; and
in the communication control process, the at least one processor distributes a same signal to the two or more light transmitting/receiving sections.

5. The free space optical communication device according to claim 1, wherein:
the communication scheme is a modulation scheme.

6. The free space optical communication device according to claim 1, wherein:
the at least one processor causes a part of the two or more light transmitting/receiving sections to use a communication scheme including error correction and causes the other part of the two or more light transmitting/receiving sections to use a communication scheme including a countermeasure against a delay time.

7. A free space optical communication system comprising:
a plurality of free space optical communication devices,
at least two or more free space optical communication devices of the plurality of free space optical communication devices each including:
a plurality of light transmitting/receiving sections; and
at least one processor configured to execute:
a communication control process of controlling communication which is to be carried out via the plurality of light transmitting/receiving sections,
in the communication control process, the at least one processor causing two or more light transmitting/receiving sections of the plurality of light transmitting/receiving sections to transmit same pieces of information in parallel according to respective different communication schemes.

8. The free space optical communication system according to claim 7, wherein:
in the communication control process, the at least one processor determines the communication schemes of the respective two or more light transmitting/receiving sections on a basis of a communication capacity, a delay time, or a retransmission rate.

9. The free space optical communication system according to claim 7, wherein:
in the communication control section, the at least one processor changes the communication schemes of the respective two or more light transmitting/receiving sections at a given timing, and causes, among the plurality of light transmitting/receiving sections, a light transmitting/receiving section which is not the two or more light transmitting/receiving sections to transmit the change.

10. The free space optical communication system according to claim 7, wherein:
in the communication control process, the at least one processor causes two or more light transmitting/receiving sections of the plurality of light transmitting/receiving sections to transmit the same pieces of information according to a certain communication scheme of the respective different communication schemes; and
in the communication control process, the at least one processor distributes a same signal to the two or more light transmitting/receiving sections.

11. The free space optical communication system according to claim 7, wherein:
the communication scheme is a modulation scheme.

12. The free space optical communication system according to claim 7, wherein:
the at least one processor causes a part of the two or more light transmitting/receiving sections to use a communication scheme including error correction and causes the other part of the two or more light transmitting/receiving sections to use a communication scheme including a countermeasure against a delay time.

13. A free space optical communication method comprising:
controlling communication which is to be carried out via a plurality of light transmitting/receiving sections,
the controlling the communication including:
causing two or more light transmitting/receiving sections of the plurality of light transmitting/receiving sections to transmit same pieces of information in parallel according to respective different communication schemes.

14. The free space optical communication method according to claim 13, wherein:
the controlling the communication includes determining the communication schemes of the respective two or more light transmitting/receiving sections on a basis of a communication capacity, a delay time, or a retransmission rate.

15. The free space optical communication method according to claim 13, wherein:
the controlling the communication includes changing the communication schemes of the respective two or more light transmitting/receiving sections at a given timing and causing, among the plurality of light transmitting/receiving sections, a light transmitting/receiving section which is not the two or more light transmitting/receiving sections to transmit the change.

16. The free space optical communication method according to claim 13, wherein:
the controlling the communication includes:
causing two or more light transmitting/receiving sections of the plurality of light transmitting/receiving sections to transmit the same pieces of information according to a certain communication scheme of the respective different communication schemes; and
distributing a same signal to the two or more light transmitting/receiving sections.

17. The free space optical communication method according to claim 13, wherein:
the communication scheme is a modulation scheme.

18. The free space optical communication method according to claim 13, wherein:
the controlling the communication includes causing a part of the two or more light transmitting/receiving sections to use a communication scheme including error correction and causing the other part of the two or more light transmitting/receiving sections to use a communication scheme including a countermeasure against a delay time.
